(19) United States
(12) Patent Application Publication
(10) Pub. No.: US 2002/0147762 A1
(43) Pub. Date: Oct. 10, 2002

(54) E-marker bracelet

(75) Inventor: John Tree, London (GB)

Correspondence Address: Seong-Kun Oh, Sierra Patent Group, Ltd., P.O. Box 6149, Stateline, NV, 89449, US

(73) Assignee: Sony Corporation and Sony Electronics, Inc.

(21) Appl. No.: 09/827,421

(22) Filed: Apr. 6, 2001

(51) Int. Cl. G06F 15/16

(52) U.S. Cl. 709/201

(57) ABSTRACT

An electronic music marker bracelet device which can be worn around a user's wrist or which can be strapped around the handle of the user's handbag by connecting the two ends of the electronic music marker bracelet device is provided. The terminal portion at one end of the strap of the device is configured to securely connect to the interface port at the other end of the strap of the device such that the user may wear the electronic music marker bracelet device around the user's wrist or securely strap around the handle of the user's handbag and have easy and quick access to the e-button on the body of the device to bookmark music clips broadcast over a registered radio or television station.

### BACKGROUND OF THE INVENTION

1. Field of the Invention

The present invention relates to portable electronic music marker devices. More particularly, the present invention relates to portable electronic music marker bracelet devices which can be worn by a user.

2. Description of the Related Art

With increase in portable electronic devices such as personal digital assistants (PDAs), WAP (Wireless Application Protocol) enabled mobile telephones, i-mode mobile telephones, multi-functional portable radio CD (Compact Disc) players, MD (Mini Disc) players and MP3 music players, there has been a steady increase in these types of devices capable of performing more operations.

Sony Corporation and its U.S. subsidiary, Sony Electronics, Inc., introduced a so called e-marker which is capable of “bookmarking” a music clip while being played on a radio and is capable of recalling the information related to the bookmarked music clip such as the name of the song, the artist, the album containing the song and so on. Using the e-marker, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the e-marker, the user can easily identify the necessary information related to the marked music clip from the e-marks provided by the e-marker.

While the e-marker has been introduced as a portable electronic device which can easily fit into a user's hand or slip into a key chain ring or a shirt pocket, to benefit from the capabilities of the e-marker, a user must have easy and ready access to the e-marker at all times especially when the user is in a surrounding where the user is listening to music broadcast over a radio station or a television station. In particular, to bookmark a music clip being broadcast over a registered radio or a television station, the user must stop whatever activity the user is engaged in at that particular time and retrieve the e-marker from the user's pocket, key chain, handbag and the like to operate the e-marker input button to book mark the music clip before the end of the broadcast. For example, in the case where the user carries the e-marker in her handbag or in her pocket attached to a key chain, it may take some time to isolate the e-marker from other items in the handbag or the pocket. Then, the user must take out the e-marker from the handbag or the pocket and access the input button of the e-marker before the music clip broadcast terminates. As with mobile telephones and other portable communication devices, by the time the user has retrieved the portable device from its stored location such as a handbag or a pocket, it may often be the case that the incoming communication attempt has terminated, as in the case of missed telephone calls on mobile telephones. While incoming telephone calls on mobile telephones may have a shorter time in which to answer the call (for example, the time duration for seven rings before reverting to voicemail) than the duration of a music clip broadcast, it may often be the case that the user catches the broadcast of a music clip which the user wishes to bookmark in the middle of its broadcast. This may typically be the case when the user is, for example, driving a car and tuning the radio for a desired radio station or music clip broadcast.

In view of the foregoing, it would be desirable to have an electronic music marker device that provides easy and ready access to the device with minimum interruption to the user's activity when the user wishes to bookmark a broadcasting music clip. Moreover, it would be desirable to have a multi-functional electronic music marker device which the user can comfortably wear that is fashionable, while providing easy and ready access to the devices.

### SUMMARY OF THE INVENTION

In one embodiment, an electronic data marker device includes a body having a first end and a second end, the first end configured to adaptively couple to the second end, and an input unit provided on the body for inputting data marks. In another embodiment, there is provided a method including connecting a first end to a second end of a data marker device, and inputting a data mark. In yet another embodiment, there is provided a method including detecting a connection to a gateway device, transmitting stored data marks to the gateway device, receiving data corresponding to the data marks, and displaying the received data. In a further embodiment, an electronic data marker device includes an elongated body means having a first end and a second end, the first end configured to adaptively couple to the second end, and input means provided on the body means for inputting data marks.

These and other features and advantages of the present invention will be understood upon consideration of the following detailed description of the invention and the accompanying drawings.

### BRIEF DESCRIPTION OF THE DRAWINGS

FIG. 1 illustrates one embodiment of a perspective view of an electronic music marker bracelet device;

FIG. 2 illustrates a detailed view of the body portion of electronic music marker bracelet device of an alternate embodiment;

FIG. 3 illustrates the music marker device of FIG. 1 integrated with a portable radio device and a headset;

FIGS. 4A and 4B illustrate the music marker device of FIG. 1 communicating with a gateway device;

FIG. 5 illustrates another embodiment of a perspective view of an electronic music marker bracelet device;

FIG. 6 illustrates the music marker device of FIG. 5 integrated with a portable radio device and a headset;

FIG. 7 illustrates the music marker device of FIG. 5 communicating with a gateway device;

FIGS. 8 is a flow chart for illustrating one embodiment of the electronic music marker bracelet device operation; and

FIG. 9 is a flow chart for illustrating one embodiment of downloading data from the user's e-marker account to the electronic music marker bracelet device.

### DETAILED DESCRIPTION

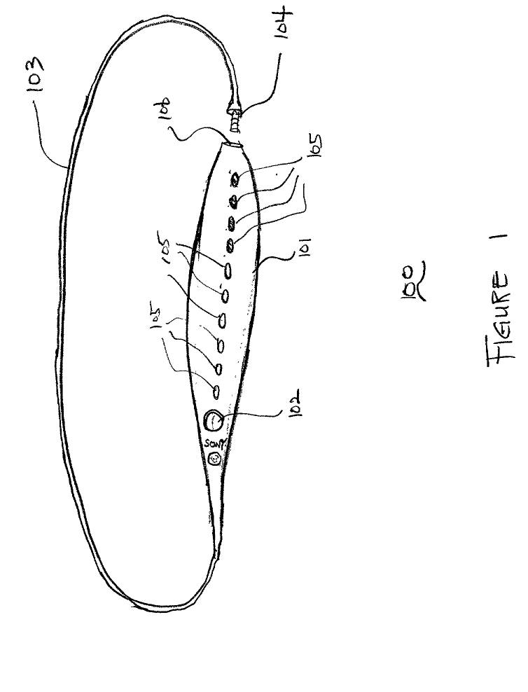

FIG. 1 illustrates one embodiment of a perspective view of an electronic music marker bracelet device. Referring to FIG. 1, electronic music marker bracelet device 100 includes body portion 101, strap portion 103 and terminal portion 104. Also shown in FIG. 1 is e-button 102 provided on body portion 101 of electronic music marker bracelet device 100. As will be discussed in further detail below, when a user wishes to bookmark a particular music clip broadcast over a registered radio or television station, the user may operate e-button 102, for example, by a single depression or a double-click type operation, respectively, to bookmark the broadcasting music clip. Further shown in FIG. 1 is a plurality of e-mark display panels 105 provided on body portion 101 of electronic music clip bracelet device 100. In one embodiment, responsive to each input operation of e-button 102 by the user, a corresponding e-mark display panel 105 may be configured to illuminate, flash or display data to indicate to the user that the music clip has been bookmarked.

Referring back to FIG. 1, body portion 101 of electronic music marker bracelet device 100 includes interface port 106 provided substantially at an end of body portion 101 on the opposite end of body portion 101 from the position of e-button 102 on body portion 101. Interface port 106 may be configured to adaptively receive terminal portion 104 such that when terminal portion 104 is coupled to interface port 106, electronic music marker bracelet device 100 may be used as a bracelet which a user can wear around her wrist. Indeed, in one embodiment, the length of strap portion 103 may be such that when terminal portion 104 is coupled to interface port 106, electronic music marker bracelet device 100 fits snugly around the user's wrist. While terminal portion 104 in FIG. 1 is shown as a male input/output jack and interface port 106 as a female port, in an alternate embodiment, terminal portion 104 may be provided as a female terminal port while interface port 106 may be provided as a male input/output jack.

In the manner described above, when the user is not operating electronic music marker bracelet device 100 to bookmark music clips broadcast over a registered radio or television station, the user may wear electronic music marker bracelet device 100 around her wrist, ankle, neck or around the strap of the user's bag, purse or luggage. In this manner, when the user desires to bookmark a particular music clip being broadcast over a registered radio or television station, the user can easily and quickly access the e-button 102 of electronic music marker bracelet device 100 to bookmark the particular broadcasting music clip. Moreover, body portion 101 and strap portion 103 may be provided with different color material (for example, plastic, or light metallic material) such as blue, red, yellow, green, orange, and so on, each of which may further be of translucent material to provide fashionable appeal in wearing or carrying around electronic music marker bracelet device.

As will be discussed in further detail below, in another embodiment, the input operation for bookmarking a music clip broadcast over a registered radio station and a registered television station may be separately provided on body portion 101 of electronic music marker bracelet device 100 as two separate e-buttons. Moreover, e-button 102 may be provided on body portion 101 with a spring-loaded mechanism or a touch-sensitive pad type input unit that is responsive to the user's light tapping on e-button 102.

Referring back to FIG. 1, as shown, each e-mark display panel 105 may separately be configured with liquid crystal displays (LCDs) to enable displaying text and image information display corresponding to the user's input commands in addition to providing illumination capability. As mentioned above, each e-mark display panels 105 is individually controlled and manipulated based on the user's input commands via e-button 102 such that when the user performs an input operation by depressing (or “clicking”) e-button 102, a corresponding e-mark display panel 105 may be configured to illuminate, flash or display corresponding data.

Moreover, as will be discussed in further detail below, when electronic music marker bracelet device 100 is connected to a gateway device such as an internet-enabled personal computer, for example, to connect to the user's e-marker account at the e-marker web site, upon verification of the user's identity corresponding to the e-marker account that the user is attempting to access, information corresponding to the e-marked songs and music clips may be downloaded and displayed in the respective e-mark display panels 105. Electronic music marker bracelet device 100 may be connected to the gateway device via a USB port, a serial port or a parallel port for cable connection, or via an infra red (IR) port for wireless connection, or any other compatible interface type such as IEEE-1394 and RS-322C interface protocols.

When a user hears a radio or television broadcast of a music clip and wishes to bookmark that particular music clip so that the user may retrieve information related to that particular music clip at a later point in time or purchase that music clip, the user operates e-button 102. Then, a corresponding e-mark display panel 105 illuminates, flashes or displays data indicating that the user has bookmarked that particular music clip. In one embodiment, the e-mark display panel 105 may also display time and date information of when the user operated e-button 102 in addition to illuminating or flashing for a predetermined period of time.

In this manner, the user may continue to bookmark music clips that are broadcast from registered radio or television stations, and with user's each operation of e-button 102 to bookmark particular music clips, a corresponding e-mark display panel 105 illuminates, flashes or displays data. In one embodiment, the pattern of illuminated e-mark display panels 105 may be predetermined and configured by the user such that a certain sequence of e-mark display panels 105 are illuminated responsive to the user's operation of e-button 102. For example, with each operation of e-button 102, electronic music marker bracelet device 100 may be configured to illuminate e-mark display panels 105 in a linear manner in sequence such that the user's first operation of e-button 102 illuminates e-mark display panel 105 positioned closest to the e-button 102 on body portion 101 of electronic music marker bracelet device 100.

Thereafter, the user's subsequent operation of e-button 102 illuminates e-mark display panel 105 positioned adjacent to the illuminated e-mark display panel 105.

Alternatively, the sequence of illuminating (flashing or displaying data on) each e-mark display panel 105 responsive to the user's operation of e-button 102 may be randomly assigned. Moreover, in one embodiment, when the user is not using electronic music marker bracelet device 100, e-mark display panels 105 may be configured to illuminate or flash a predetermined pattern or a sequence of predetermined patterns for display. In particular, electronic music marker bracelet device 100 may be configured to illuminate a predetermined sequence of e-mark display panels 105 for a predetermined time period. For example, in one embodiment, every alternate e-mark display panel 105 may be configured to illuminate for a predetermined period of time such as two seconds, with each alternate e-mark display panels 105 being illuminated for each subsequent two second period until the last e-mark display panel 105 on body portion 101 is reached. Thereafter, in one embodiment, e-mark display panels 105 may be configured to concurrently illuminate (or “flash”) for a given period of time to alert the user wearing the electronic music marker bracelet device 100 that the sequence of e-mark display panel illumination is terminated.

When the user connects electronic music marker bracelet device 100 to a gateway device such as a personal computer and the like, and logs onto the user's acount at e-marker.com web site, the information corresponding to the e-marked music clips may be transferred to the user's e-marker account. Moreover, in one embodiment, electronic music marker bracelet device 100 may be configured to receive information corresponding to each bookmarked music clip from the e-marker.com web site such that each e-mark display panel 105 may be configured to display information corresponding to the particular music clip that the user bookmarked. For example, electronic music marker bracelet device 100 may receive information corresponding to the music clip such as the name of the music clip, the name of the artist, the name of the album for the music clip, and so on. Additionally, electronic music marker bracelet device 100 may also receive image data (for example, in compressed or uncompressed form of .jpg, .gif and other compatible image file formats) corresponding to the music clip such as a still image of the album cover for the music clip, or a still image of the artist for the music clip for display on the respective e-mark display panels 105. Alternatively, electronic music marker bracelet device 100 may be configured to receive a short video clip, an animated music video clip corresponding to the bookmarked music clip, or a video clip of the artist for the e-marked music clip (for example, in formats such as compressed or uncompressed .mpg and .avi formats) for display on the corresponding e-mark display panels 105. In one embodiment, the image data may be concurrently displayed on e-mark display panel 105 with the text data. Alternatively, only video data or text data may be displayed on a particular e-mark display panel 105.

Additional detailed information relating to the operation of the electronic music markers can be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

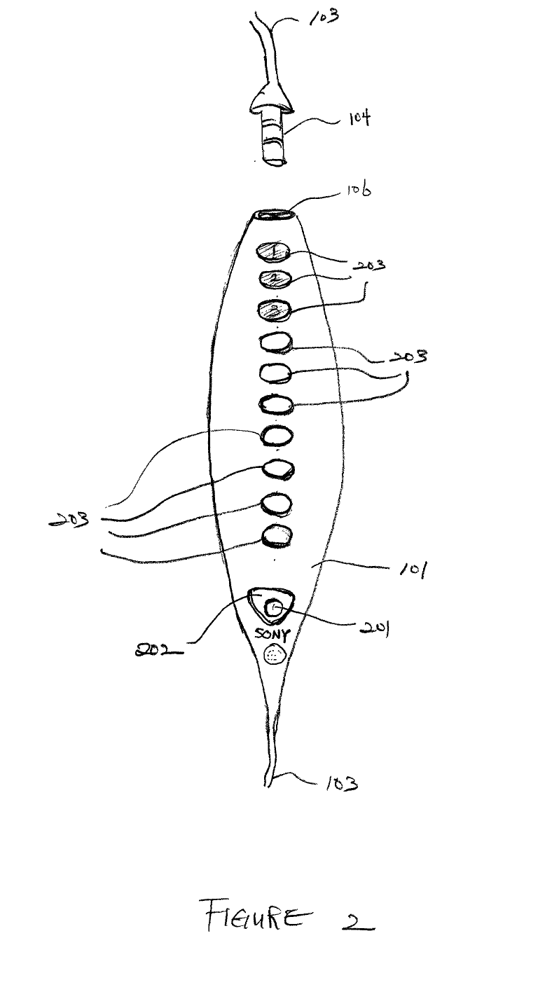

FIG. 2 illustrates a detailed view of body portion 101 of electronic music marker bracelet device of an alternate embodiment. Referring to FIG. 2, there are provided first and second e-buttons 201, 202 on body portion 101 of electronic music marker bracelet device 100. As discussed above, in this embodiment, a user's operation of first e-button 201 may be configured to bookmark music clips broadcast over a registered radio station, while the user's operation of second e-button 202 may be configured to bookmark music clips broadcast over a registered television station. Moreover, as can be seen from FIG. 2, first e-button 201 is provided on body portion 101 substantially within second e-button 201. In this manner, it is possible to provide separate input e-buttons for marking music clips broadcast over a registered radio and television stations, integrated onto body portion 101. Furthermore, in one embodiment, first and second e-buttons 201, 202 may be provided on body portion 101 with a spring-loaded mechanism or touch-sensitive pad type input unit for receiving input commands from the user.

Further shown in FIG. 2 are ten e-mark display panels 203 provided on body portion 101 of electronic music marker bracelet device 100 positioned in a substantially linear manner. As shown, each e-mark display panel 203 is provided equidistant to each other on body portion 101 along the length of body portion 101 between the position of interface port 106 and the positions of first and second e-buttons 201, 202. Additionally, each e-mark display panel 203 is provided with text and/or image capability such that in addition to illuminating or flashing in response to the user's operation of either of first and second e-buttons 201, 202, e-mark display panels 203 may be configured to display text data such as time and date information, and image data such as a compressed image or compressed video clip. For example, as shown in FIG. 2, three e-mark display panels 203 are illuminated, each further displaying a text data such as “1”, “2”, and “3”. In this manner, the user can readily determine the number of bookmarks the user has input to electronic music marker bracelet device 100 by a quick glance at the last e-mark display panel 203 for the displayed, illuminated number.

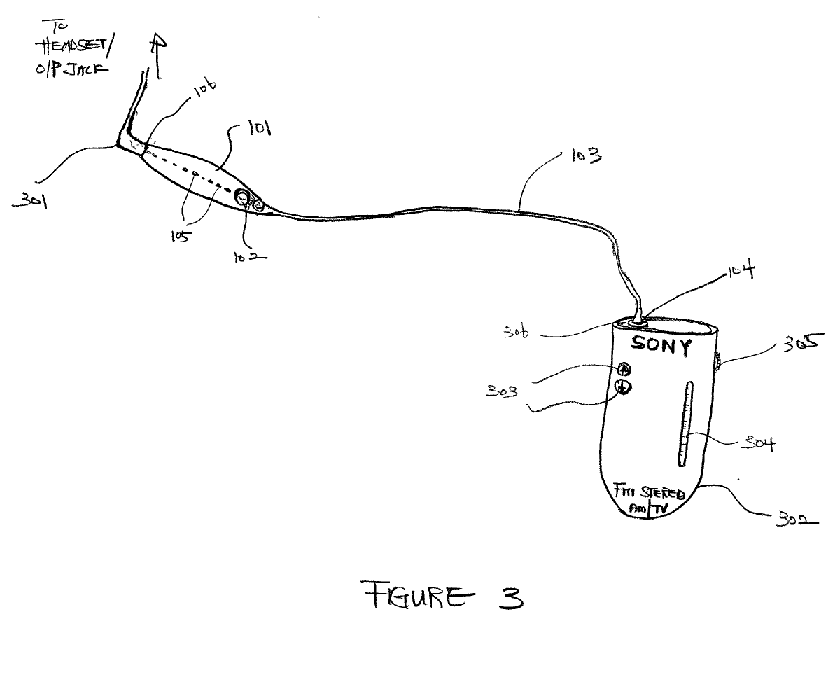

FIG. 3 illustrates the music marker device of FIG. 1 integrated with a portable radio/television tuner device and a headset. Referring to FIG. 3, interface port 106 of electronic music marker bracelet device 100 is connected to output jack 301 of a head set device such as an ear-phone or a head-phone (or any other types of output devices such as a stereo speaker set), while terminal portion 104 of electronic music marker bracelet device 100 is connected to input terminal 306 of radio/television tuner device 302. Radio/television tuner device 302 may be a commercially available portable device such as Walkman®, and MiniDisc® players available from Sony Corporation, or any other types of radio and/or television tuner stereo device. Referring back to FIG. 3, radio/television tuner device 302 may be provided with station/channel selection unit 303, output volume control unit 305, and station/channel display unit 304. In one embodiment, radio/television tuner device 302 may include internet-enabled telephone such as WAP or i-mode telephones, MP3 enabled portable devices including cellular, PCS phones and Personal Handyphones, each provided with radio/television tuner capabilities.

As shown in FIG. 3, in one embodiment, electronic music marker bracelet device 100 may be integrated with portable radio/television tuner device 302 such that when a user is using portable radio/television tuner device 302, the user can integrate the functionality of electronic music marker bracelet device 100 by connecting interface port 106 to output jack 301 and terminal portion 104 of electronic music marker bracelet device 100 to input terminal 306 of radio/television tuner device 302. In this manner, whether the user may be jogging, walking, pushing a stroller on a walk, sitting on a plane, traveling or engaged in any other types of activities, when the user wishes to bookmark a music clip broadcast over a registered radio or television station while listening to radio/television tuner device 302, the user may readily bookmark the desired music clip by operating e-button 102 of electronic music marker bracelet device 100 which is integrated with radio/television tuner device 302.

FIGS. 4A and 4B illustrate the music marker device of FIG. 1 communicating with a gateway device. Referring to FIGS. 4A and 4B, gateway device 410 may include a personal computer, a personal digital assistant, a WAP-enabled mobile telephone, an i-mode mobile telephone configured to operate under the i-mode protocol for wireless internet connection, or a television set enabled for web-TV internet access. Interface terminal 401 of gateway device shown in FIG. 4A may be configured in a substantially similar manner as terminal portion 106 of electronic music marker bracelet device 100, and may include a cable-type hard wire connection using one of a USB port, a serial port, and a parallel port. Alternatively, interface terminal 411 of gateway device 410 shown in FIG. 4B may include a wireless interface terminal such as an infra red (IR) port or a Bluetooth enabled port. In this case, electronic music marker bracelet device 100 may be provided with a similar complimentary wireless interface communication port 420 provided on body portion 101 for communication with the gateway device.

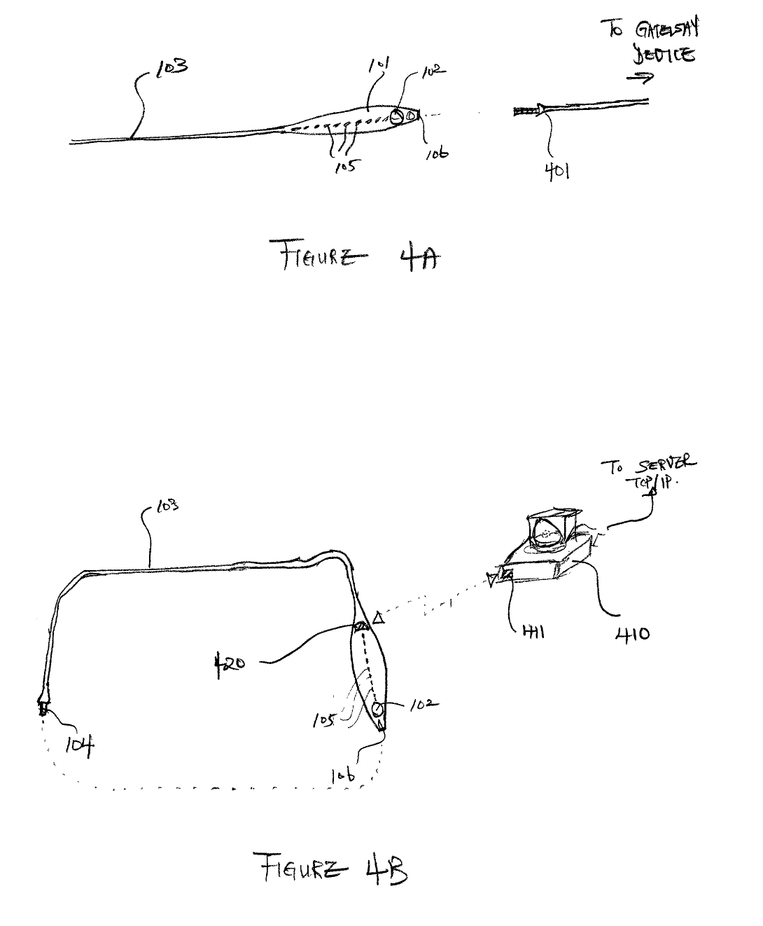

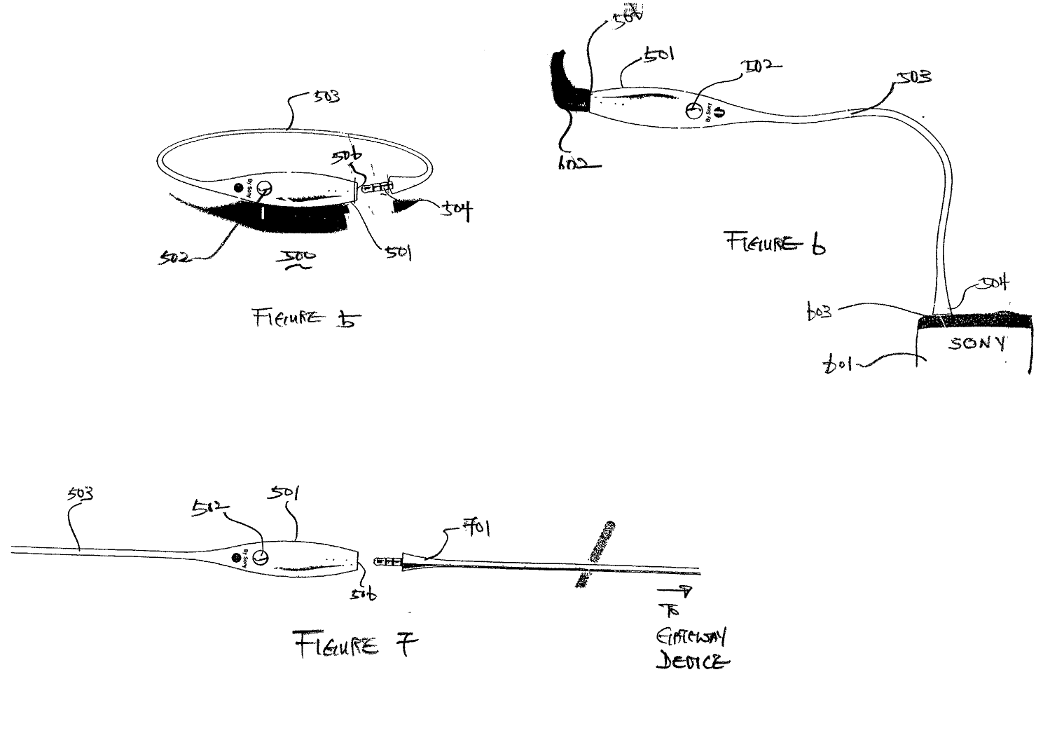

FIG. 5 illustrates another embodiment of a perspective view of an electronic music marker bracelet device, FIG. 6 illustrates the music marker device 500 of FIG. 5 integrated with a portable radio device and a headset, and FIG. 7 illustrates music marker device 500 of FIG. 5 communicating with a gateway device. Referring to FIG. 5, e-button 502 is provided on body portion 501 of electronic music marker bracelet device 500, and interface port 506 may be configured to couple to terminal portion 504 of electronic music marker bracelet device 500 such that strap portion 503 and body portion 501 snugly fits around a user's wrist to be worn as a bracelet. Referring to FIG. 6, electronic music marker bracelet device 500 in an alternate embodiment may be integrated with radio/television tuner device 601 such that interface port 506 is connected to output jack 602 of radio/television tuner device 601 while terminal portion 504 at one end of strap portion 503 is connected to input terminal 603 of radio/television tuner device 601. Finally, referring to FIG. 7, interface port 506 of electronic music marker bracelet device 500 may be coupled to a gateway device via interface terminal 701 such that electronic music marker bracelet device 500 may communicate with the gateway device to transmit and/or receive data corresponding to the user's inputted bookmarks.

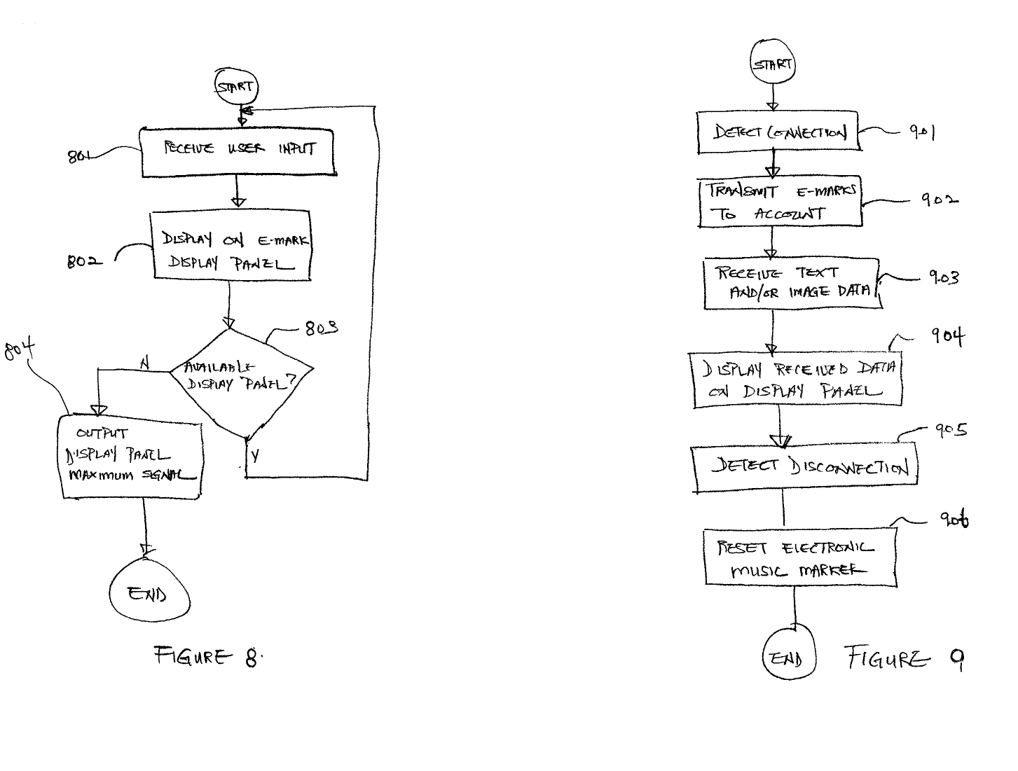

FIG. 8 is a flow chart for illustrating one embodiment of the electronic music marker bracelet device operation. Referring to FIGS. 2 and 8, at step 801, electronic music marker bracelet device 100 detects user's input operation of one of first and second e-buttons 201, 202, respectively. Then, at step 802, electronic music marker bracelet device 100 illuminates or flashes a corresponding e-mark display panel 203. As discussed above, in one embodiment, the corresponding e-mark display panel 203 may also display time and/or date information of the user's input operation of first or second e-buttons 201, 202, respectively.

At step 803, electronic music marker bracelet device 100 determines whether all available e-mark display panels 203 are being used (for example, illuminated or flashing in response to user's input operation of first or second e-buttons 201, 202, respectively). If it is determined that there are e-mark display panels 203 available, electronic music marker bracelet device 100 waits for further input operation by the user at step 801. On the other hand, if it is determined at step 803 that all available e-mark display panels 203 are in use, then at step 804, electronic music marker bracelet device 100 generates an output signal to inform the user that electronic music marker bracelet device 100 has reached its maximum number of e-marks that it can handle, and the procedure ends. In one embodiment, the output signal from electronic music marker bracelet device 100 to inform the user that it has reached its maximum number of e-marks it can handle may be an audible output signal such as an audible tone via an audio output terminal (not shown). Alternatively, electronic music marker bracelet device 100 may be configured to flash all e-mark display panels 203 simultaneously for a predetermined period of time to visually indicate to the user that it has reached its maximum number of e-marks that it can handle.

FIG. 9 is a flow chart illustrating one embodiment of downloading data from the user's e-marker account to electronic music marker bracelet device 100. Referring to FIGS. 1, 2 and 9, at step 901, electronic music marker bracelet device 100 detects a connection to a gateway device such as a personal computer connected to the internet. After the user enters the user's account information and performing necessary e-marker account access steps at the gateway device, at step 902, data corresponding to the e-marks (bookmarks) stored in electronic music marker bracelet device 100 is transmitted to the user's e-marker account via the gateway device, and in response, the corresponding text and/or image (including video) data are retrieved from a server terminal of e-marker.com's web site and transmitted to the user's e-marker account. Then, at step 903, the text and/or image data corresponding to each e-marks are downloaded onto electronic music marker bracelet device 100. At step 904, the downloaded text and/or image data are displayed on each corresponding e-mark display panel 203 on electronic music marker bracelet device 100.

When the user disconnects electronic music marker bracelet device 100 from the gateway device, the termination of the connection between electronic music marker bracelet device 100 and the gateway device is detected at step 905. Then, at step 906, electronic music marker bracelet device 100 is reset such that previously stored e-marks inputted by the user may be erased from electronic music marker bracelet device 100, and correspondingly, the illuminated e-mark display panels 203 are turned off. The user may then operate first and second e-buttons 201, 202, respectively, again to input additional bookmarks of music clip broadcasts from registered radio and television broadcast stations.

As discussed above, in one embodiment, an electronic music marker bracelet device is provided which is configured to perform the functions of an e-marker device and is designed with minimal weight and visually pleasing shape and color such that users may wear the electronic music marker bracelet device around the user's wrist with comfort, and have ready access to the input e-button 102 of the device. Moreover, since electronic music marker bracelet device 100 is readily viewable when the user is wearing the device around her wrist, the operation of e-button 102 to bookmark a particular music clip broadcast over a registered radio or television station is simple and fast, with minimal intrusion into the user's activity at the time the user wishes to mark the particular music broadcast. Additionally, with e-mark display panels 105 readily viewable through relatively the same motion as a user checking the time from a wrist watch, the user can easily ascertain the number of music clips that the user has marked. Also, e-mark display panels 105 may be provided in a substantially non-overlapping manner on body portion 101 of electronic music marker bracelet device 100 with each e-mark display panel 105 having substantially the same dimensions, for example, in the shape of a circle, a square, a triangle or a rectangle, arranged substantially in a linear manner along body portion 101. Alternatively, each e-mark display panel 105 may be designed with a unique dimension.

Moreover, in one embodiment, each e-mark display panels 105 may be configured to selectively display an indication of the received data marks (bookmarks), examples of such indication including an image corresponding to the data mark, a text corresponding to the data mark, or a combination of the image and text. Also, the indication on e-mark display panels 105 may be displayed in conjunction with the respective e-mark display panels 105 being illuminated or flashing. Furthermore, e-mark display panels 105 may be configured to display, upon synchronization with user's e-marker account via an internet connection through a gateway device, one or more of a title of the bookmarked music clip and the corresponding artist of the bookmarked music clip, a title of the album for the bookmarked music clip and a graphical display of the music album and the artist each corresponding to the bookmarked music clip.

In this manner, an electronic music marker bracelet device which can be worn around a user's wrist or which can be strapped around the handle of the user's handbag by connecting the two ends of the electronic music marker bracelet device is provided. The terminal portion at one end of the strap of the device is configured to securely connect to the interface port at the other end of the strap of the device such that the user may wear the electronic music marker bracelet device around the user's wrist or securely strap around the handle of the user's handbag and have easy and quick access to the e-button on the body of the device to bookmark music clips broadcast over a registered radio or television station.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An electronic data marker device, comprising:
a body having a first end and a second end, said first end configured to adaptively couple to said second end; and
an input unit provided on said body for inputting data marks.

2. The device of claim 1 wherein said body includes a substantially elongated strap portion provided between said first and second ends.

3. The device of claim 1 wherein said first end of said body includes an interface port, and said second end of said body includes an output port.

4. The device of claim 3 wherein said output port is configured to couple to a gateway device.

5. The device of claim 4 wherein said gateway device includes one of a personal computer, a wireless internet access enabled mobile telephone or personal digital assistant, and an internet access enabled television.

6. The device of claim 1 further including a display unit having a plurality of display panels provided on said body, said display unit configured to receive said data marks from said input unit and correspondingly display said data marks on said plurality of display panels.

7. The device of claim 6 wherein said display unit includes one of a liquid crystal display and a touch-sensitive type display unit.

8. The device of claim 6 wherein each of said plurality of display panels on said display unit is non-overlapping.

9. The device of claim 6 wherein each of said plurality of panels has substantially the same dimensions.

10. The device of claim 9 wherein said plurality of display panels are positioned on said display unit with substantially the same distance therebetween.

11. The device of claim 9 wherein each of said plurality of display panels is one of a circular shape, square shape, a triangular shape, and a rectangular shape.

12. The device of claim 6 wherein said display unit is configured to selectively display an indication of said received data marks on a corresponding one of said plurality of display panels.

13. The device of claim 12 wherein said display unit displays said indication of received data marks by illuminating or flashing said corresponding one or more of said plurality of display panels.

14. The device of claim 1 wherein said data marks include data corresponding to a broadcast of a music file.

15. The device of claim 14 wherein said data corresponding to said broadcast of said music file includes a time and date information of said music file broadcast.

16. The device of claim 1 wherein said input unit includes one of a spring loaded button and a touchpad input panel.

17. The device of claim 1 wherein said input unit includes a music broadcast mark button and a television broadcast mark button.

18. The device of claim 1 further including a communication port provided on said body for transmitting and/or receiving data to/from an external device.

19. The device of claim 18 wherein said communication port includes one or more of an infra red (IR) port, and a Bluetooth port.

20. The device of claim 18 wherein said external device includes one or more of a personal computer, a personal digital assistant, a television set, a mobile telephone, a pager, and a wireless communication device.

21. The device of claim 18 wherein said external device is configured to correspondingly display said received data marks on said external device.

22. The device of claim 21 wherein said data marks include music marks corresponding to music files and further, wherein said data marks displayed on said external device includes information corresponding to said each received music mark.

23. The device of claim 22 wherein said music marks displayed on said external device includes one or more of a title of the music corresponding to said each music mark, a name of the artist corresponding to said each music mark, a title of the album corresponding to said each music mark, and a graphical display of an album cover corresponding to said each music mark.

24. A method, comprising:
connecting a first end to a second end of a data marker device; and
inputting a data mark.

25. The method of claim 24 further including displaying the received data mark.

26. The method of claim 24 wherein said step of displaying said data mark includes one or more of illuminating and flashing a display panel on said device corresponding to the receiving step.

27. The method of claim 24 further including:
determining that maximum number of data marks have been received; and
outputting an output signal responsive to said determining step.

28. The method of claim 27 wherein said output signal includes one of an audio signal and a display signal.

29. The method of claim 27 wherein said maximum number is ten.

30. The method of claim 24 wherein said data marks include one or more of a time stamp information and a date stamp information.

31. A method, comprising:
detecting a connection to a gateway device;
transmitting stored data marks to said gateway device;
receiving data corresponding to said data marks; and
displaying said received data.

32. The method of claim 31 further including:
detecting a disconnection from said gateway device; and
resetting said stored data marks.

33. The method of claim 32 wherein the resetting step includes deleting the stored data marks.

34. The method of claim 31 wherein said connection includes one of a cable connection and a wireless connection.

35. The method of claim 31 wherein said gateway device includes one of a personal computer and a server terminal.

36. The method of claim 31 wherein said received data includes one or more of a text data, a still image data, an animated image data, and a video data corresponding to the stored data marks.

37. An electronic data marker device, comprising:
an elongated body means having a first end and a second end, said first end configured to adaptively couple to said second end; and
input means provided on said body means for inputting data marks.
